(19) United States
(12) Patent Application Publication
(10) Pub. No.: US 2007/0191061 A1
(43) Pub. Date: Aug. 16, 2007

(54) APPARATUS FOR SWITCHING SIM CARDS DISPOSED IN COMMUNICATION EQUIPMENT

(76) Inventor: CHIH-HUNG CHUANG, Taoyuan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/671,597

(22) Filed: Feb. 6, 2007

(30) Foreign Application Priority Data
Feb. 15, 2006 (TW) 095104986

(51) Int. Cl. H04B 1/38

(52) U.S. Cl. 455/558

(57) ABSTRACT

The invention provides an apparatus for switching from a first Subscriber Identity Module (SIM) card with a set of first contact points to a second SIM card with a set of second contact points. The first SIM card and the second SIM card are both disposed inside a communication equipment. When a user replaces the first SIM card with the second SIM card, the user rotates the circumference of the disc exposed outside the casing, until the second SIM card is positioned so that the second set of contact points contact the fourth set of contact points on the inner wall, and the resilient pins on the inner wall pass through the second set of openings to contact the third contact points on the battery.

### BACKGROUND OF THE INVENTION

1. Field of the Invention

The present invention relates to an apparatus for switching from a first SIM card to a second SIM card disposed in a communication equipment.

2. Description of the Prior Art

In the present days, users of the Global System for Mobile (GSM) gain access to the Internet services through inserting a Subscriber Identification Module (SIM) card into a mobile phone. Through the use of the SIM card, users can become registered users of the GSM to enjoy any services provided.

The popularity of mobile phones increases as they become more and more widely used. The number of users having more than one SIM card is also rising. However, the majority of the mobile phones in the present markets contain a single SIM card only, and the SIM card slot found in most mobile phones is located between the battery and the mobile phone. If a user wants to use two or more SIM cards in a mobile phone, he must first disconnect the power, dislodge the battery, and then switch the SIM cards manually, to make the mobile phone workable; therefore, it is not very convenient. Furthermore, because the size of SIM cards is very small, the problem of losing SIM cards during card switching can easily happen.

Another method for resolving the problems associated with two or more SIM cards is to carry multiple phones at the same time, and each phone can contain one SIM card. This method is commonly used by many people.

Furthermore, there are mobile service providers who currently provide the service of modifying the SIM card slot on the back casing of a mobile phone. However, the user must install additional circuits, which cause the outer casing of the battery of the mobile phone to be different and lead to poor effects. There are also mobile service providers who add the SIM card onto the battery, and rely on connection and disconnection of the battery to switch between the two SIM cards. Both methods rely on the installation of additional circuits by the user, instead of being a service provided by the original mobile phone factory. The additional circuits often lead to poor effects and possible malfunction in the original circuits of the mobile phone. Scenarios like incomplete disconnection of battery when dislodging a SIM card from a mobile phone could also happen, causing information in the SIM card to be lost, so the user can no longer use the SIM card.

Accordingly, a scope of the present invention is to provide an apparatus to resolve the aforementioned problems.

### SUMMARY OF THE INVENTION

A scope of the invention is to provide an apparatus for switching from a first SIM card to a second SIM card in a communication equipment.

The invention provides an apparatus for switching from a first Subscriber Identity Module (SIM) card with a set of first contact points to a second SIM card with a set of second contact points. The first SIM card and the second SIM card are both disposed inside a communication equipment including a battery with a set of third contact points and a casing with an inner wall. On the inner wall, there are a set of resilient pins for contacting the third set of contact points on the battery and a set of fourth contact points for contacting the first set of contact points of the first SIM card or the second set of contact points of the second SIM card.

The apparatus includes a disc, a first slot, a second slot, a first set of openings, and a second set of openings. The disc, rotatably mounted on the inner wall, has a circumference partially exposed outside the casing of the communication equipment. The first slot, formed on the disc, is for containing the first SIM card inserted securely into the first slot where the first set of contact points of the first SIM card are disposed toward the inner wall.

A second slot, formed on the disc, is for containing the second SIM card inserted securely into the second slot where the second set of contact points of the second SIM card are disposed toward the inner wall. A first set of openings, formed through the disc, correspond to the first slot, whereas the second set of openings, formed through the disc, correspond to the second slot.

If a user operates the communication equipment by the use of the first SIM card, the first SIM card is positioned so that the first set of contact points contact the fourth set of contact points on the inner wall, and the resilient pins on the inner wall pass through the first set of openings to contact the third set of contact points on the battery.

On the other hand, the user operates the communication equipment by use of the second SIM card replacing the first SIM card, the user rotates the circumference of the disc exposed outside the casing until the second SIM card is positioned so that the second set of contact points contact the fourth set of contact points on the inner wall, and the resilient pins on the inner wall pass through the second set of openings to contact the third contact point.

Differing from the prior art, applying the apparatus, according to the invention, in an electronic device only requires the user to rotate the disc exposed outside the casing to achieve disconnection of battery and switching of SIM cards at the same time, without the need to dislodge battery. This can avoid inconvenience in operation and problems caused following installation of additional circuits for the use of the two SIM cards mentioned in the prior art.

The advantage and spirit of the invention may be understood by the following recitations together with the appended drawings.

### BRIEF DESCRIPTION OF THE APPENDED DRAWINGS

FIG. 1 is a schematic of the apparatus according to the invention.

FIG. 2A is a schematic of a mobile phone with the apparatus according to the invention.

FIG. 2B is a schematic of the back of the mobile phone with the apparatus according to the invention.

FIG. 2C is a schematic of the interior of the mobile phone with the apparatus according to the invention.

FIG. 2D is an expanded schematic of the first set of openings and resilient pins of the apparatus according to the invention.

FIG. 2E is a side view of the mobile phone with the apparatus according to the invention.

### DETAILED DESCRIPTION OF THE INVENTION

The invention provides an apparatus for switching from a first Subscriber Identity Module (SIM) card with a set of first contact points to a second SIM card with a set of second contact points. The first SIM card and the second SIM card are both disposed inside a communication equipment including a battery with a set of third contact points and a casing with an inner wall. On the inner wall, there are a set of resilient pins for contacting the third set of contact points on the battery and a set of fourth contact points for contacting the first set of contact points of the first SIM card or the second set of contact points of the second SIM card.

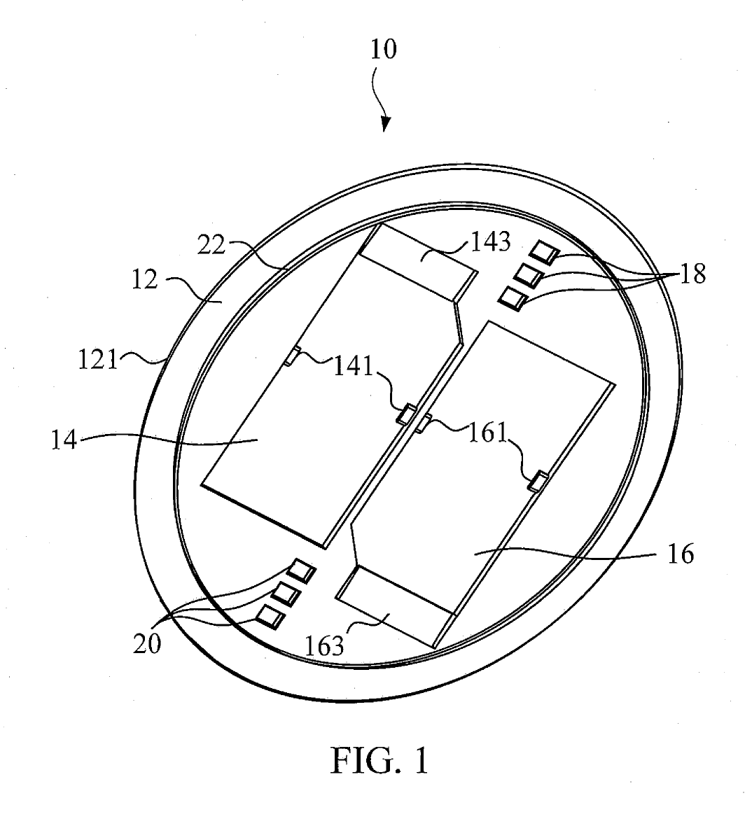

Referring to FIG. 1, FIG. 1 is a schematic of the apparatus 10 according to the invention. Referring to FIG. 1, the apparatus 10 includes a disc 12, a first slot 14, a second slot 16, a first set of openings 18, and a set of second openings 20. The disc 12, rotatably mounted on the inner wall, has a circumference 121 partially exposed outside the casing of the communication equipment. The first slot 14, formed on the disc 12, is for the first SIM card to be inserted securely into the first slot 14 where the first set of contact points of the first SIM card are disposed toward the inner wall. The second slot 16, formed on the disc 12, is for the second SIM card to be inserted securely into the second slot 16 where the second set of contact points on the second SIM card are disposed toward the inner wall. The first set of openings 18, formed through the disc 12, correspond to the first slot 14, whereas the second set of openings 20, formed through the disc 12, correspond to the second slot 16.

If a user operates the communication equipment by the use of the first SIM card, the first SIM card is positioned so that the first set of contact points contact the fourth set of contact points on the inner wall, and the resilient pins on the inner wall pass through the first set of openings 18 to contact the third set of contact points on the battery. If the user operates the communication equipment by the use of the second SIM card replacing the first SIM card, the user rotates the circumference 121 of the disc 12 exposed outside the casing until the second SIM card is positioned so that the second set of contact points contact the fourth set of contact points on the inner wall, and the resilient pins on the inner wall pass through the second set of openings 20 to contact the third contact point.

Using an example in which the communication equipment is a mobile phone, a detailed description of the application of the apparatus, according to the invention, in the mobile phone is provided to better identify the features and spirits of the invention.

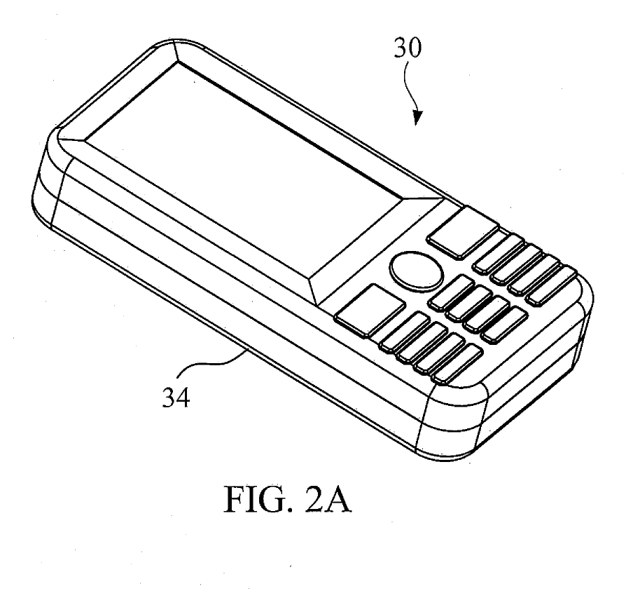

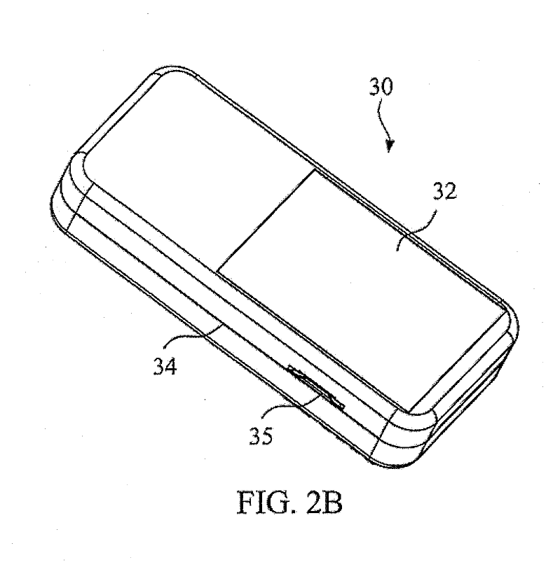

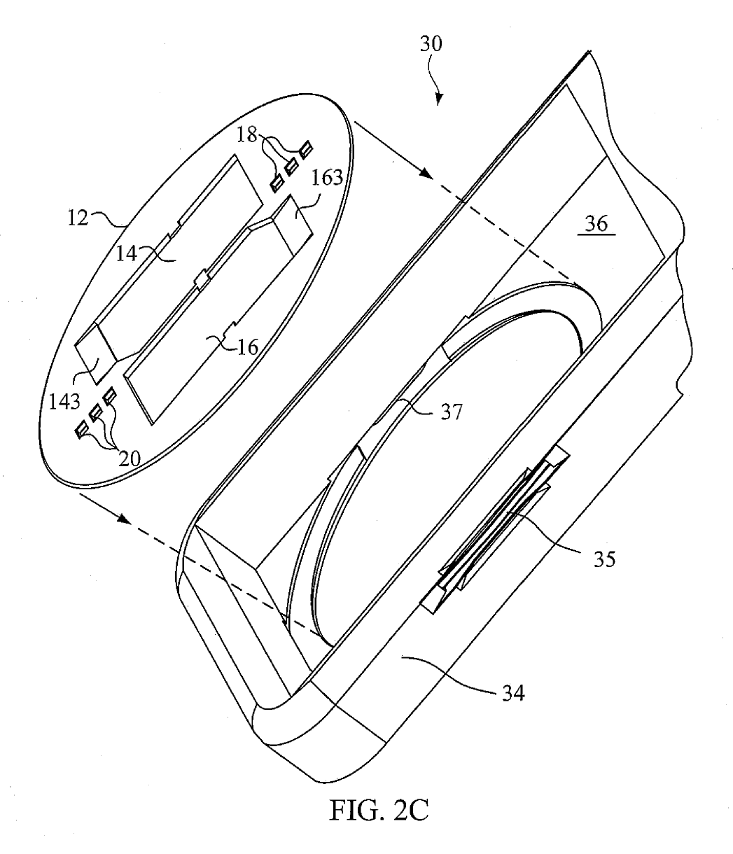

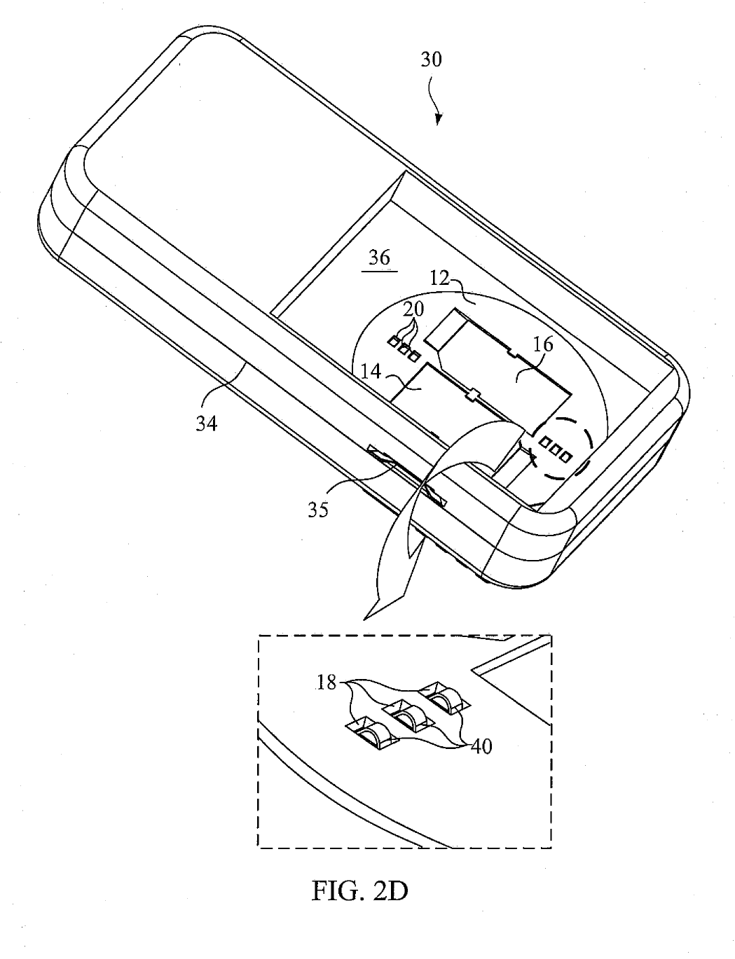

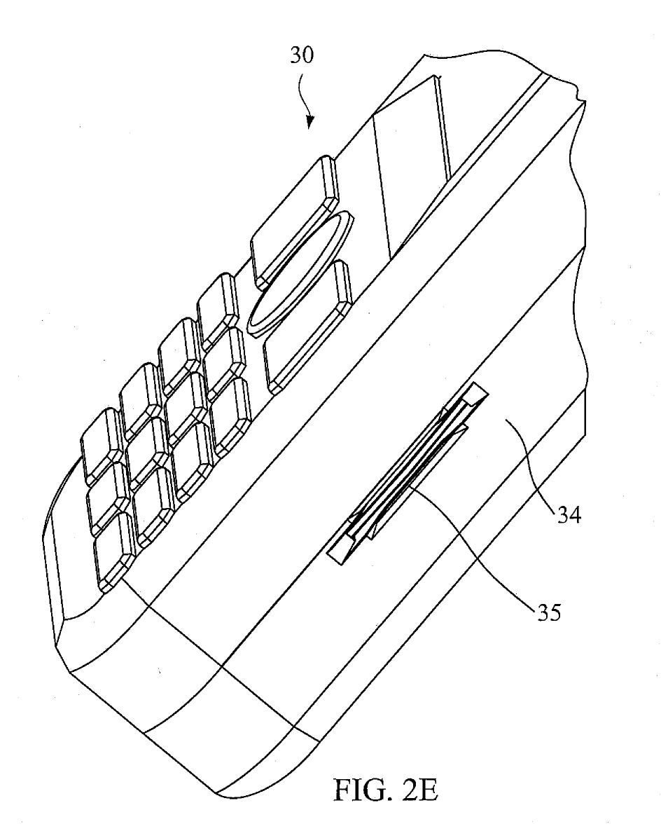

Referring to FIG. 2A through FIG. 2E, FIG. 2A through FIG. 2E are figures depicting a preferred embodiment of the apparatus. FIG. 2A is a schematic of a mobile phone 30 with the apparatus according to the invention. FIG. 2B is a schematic of the back of the mobile phone 30 with the apparatus according to the invention. FIG. 2C is a schematic of the interior of the mobile phone 30 with the apparatus according to the invention. FIG. 2D is an expanded schematic of the first set of openings and resilient pins of the apparatus according to the invention. FIG. 2E is a side view of the mobile phone with the apparatus according to the invention.

Referring to FIG. 2A through FIG. 2E, the scope of the invention is to provide an apparatus for switching from a first SIM card with a set of first contact points to a second SIM card with a set of second contact points. The first SIM card and the second SIM card are both dispatched inside a mobile phone 30 including a battery 32 with a set of third contact points and a casing 34 with an inner wall 36. On the inner wall 36, there are a set of resilient pins 38 for contacting the third set of contact points on the battery 32 and a set of fourth contact points for contacting the first set of contact points of the first SIM card or the second set of contact points of the second SIM card. The third set of contact points of the battery 32 are metal pins on regular mobile phone, for providing power to the mobile phone by connecting to the conductive resilient pins within the mobile phone.

The apparatus 10 includes a disc 12, a first slot 14, a second slot 16, a first set of openings 18, and a set of second openings 20. An opening 35 is formed at one side of the casing 34 of the mobile phone 30, allowing the disc 12 to protrude outside the opening 35, so as to enable the user to use the disc 12 of the casing 34 to switch from the first SIM card to the second SIM card.

The disc 12, rotatably mounted on the inner wall 36, has a circumference 121 partially exposed outside the casing 34 of the mobile phone 30. The disc 12 thereon provides a plurality of clasps 22, and the inner wall 36 of the mobile phone 30 thereon provides a plurality of tenons 37. The disc 12 thereof inlays into the inner wall 36 of the mobile phone 30 by inlaying the plurality of tenons 37 into the plurality of clasps 22.

The first slot 14, formed on the disc 12, is for the first SIM card to be inserted securely into the first slot 14 where the first set of contact points of the first SIM card are disposed toward the inner wall 36. The first slot 14 has a plurality of columns 141 for assisting the first SIM card to be positioned within the first slot 14. One end of the first slot 14 has a notch 143, extended outwardly from the first slot 14, for assisting the first SIM card to be inserted into the first slot 14.

The second slot 16, formed on the disc 12, is for the second SIM card to be inserted securely into the second slot 16 where the second set of contact points of the second SIM card are disposed toward the inner wall 36. The second slot 16 has a plurality of columns 161 for assisting the second SIM card to be positioned within the second slot 16. One end of the second slot 16 has a notch 163, extended outwardly from the second slot 16, for assisting the second SIM card to be inserted into the second slot 16.

The first set of openings 18, formed through the disc 12, correspond to the first slot 14, wherein the plurality of resilient pins 40 pass through the first set of openings 18 to assist the disc 12 to stay at a certain position.

The second set of openings 20, formed through the disc 12, correspond to the second slot 16, wherein the plurality of resilient pins 40 pass through the second set of openings 20 to also assist the disc 12 to stay at a certain position.

If a user operates the mobile phone 30 by the use of the first SIM card, the first SIM card is positioned so that the first set of contact points contact the fourth set of contact points on the inner wall 36, and the resilient pins 40 on the inner wall 36 pass through the first set of openings 18 to contact the third set of contact points of the battery 32.

If the user operates the mobile phone 30 by the use of the second SIM card replacing the first SIM card, the user rotates the circumference 121 of the disc 12 exposed outside the casing 34 until the second SIM card is positioned so that the second set of contact points contact the fourth set of contact points on the inner wall 36, and the resilient pins 40 on the inner wall 36 pass through the second set of openings 20 to contact the third contact point of the battery 32.

By rotating the disc 12, the resilient pins 40 is forced to detach from the first set of openings 18, causing the resilient pins 40 to detach from the third contact point of the battery 32, so that the power source of the mobile phone 30 can be disconnected. The resilient pins 40 are then blocked by the disc 32 until the disc 12 is rotated to the second set of openings 20 and pass through the second set of openings 20, to provide the power source of the mobile phone 30. Similarly, when rotating the disc 12, the first contact points of the first SIM card is detached from the fourth contact points on the inner wall 36, thus disconnecting the mobile communication service. Not until the disc 12 is rotated to where the second contact points of the second SIM card contact the fourth contact points on the inner wall 36, that the mobile communication service of the mobile phone 30 is resumed.

The communication equipment in the invention can be a mobile phone, personal digital assistant (PDA), or other communication equipments requiring SIM cards.

The apparatus, according to the invention, can be applied to a communication equipment with a rotatable disc mounted on the inner wall of the casing of the communication equipment, and the disc thereon provides two slots and two sets of openings for switching to another SIM card by easily rotating the part of the disc protruded outside a side of the casing to disconnect the power source. Based on the invention, the switching of two or more SIM cards can be easily achieved without the need to install additional circuits, thus providing the most convenience to users.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An apparatus for switching from a first Subscriber Identity Module (SIM) card with a set of first contact points to a second SIM card with a set of second contact points, the first SIM card and the second SIM card both being disposed inside a communication equipment comprising a battery with a set of third contact points and a casing with an inner wall. On the inner wall, a set of resilient pins for contacting the third set of contact points on the battery and a set of four contact points for contacting the first set of contact points of the first SIM card or the second set of contact points of the second SIM card, said apparatus comprising:
a disc, rotatably mounted on the inner wall, having a circumference partially exposed outside the casing of the communication equipment;
a first slot, formed on the disc, for containing the first SIM card inserted securely into the first slot where the first set of contact points on the first SIM card are disposed toward the inner wall;
a second slot, formed on the disc, for containing the second SIM card inserted securely into the second slot where the second set of contact points on the second SIM card are disposed toward the inner wall;
a first set of openings, formed through the disc, corresponding to the first slot; and
a second set of openings, formed through the disc, corresponding to the second slot;
wherein if a user operates the communication equipment by use of the first SIM card, the first SIM card is positioned so that the first set of contact points contact the fourth set of contact points on the inner wall, and the resilient pins on the inner wall pass through the first set of openings to contact the third set of contact points on the battery;
wherein if the user operates the communication equipment by use of the second SIM card replacing the first SIM card, the user rotates the circumference of the disc exposed outside the casing, until the second SIM card is positioned so that the second set of contact points contact the fourth set of contact points on the inner wall, and the resilient pins on the inner wall to pass through the second set of openings to contact the third contact point.

2. The apparatus of claim 1, wherein the disc thereon provides a plurality of clasps, the inner wall of the communication equipment thereon provides a plurality of tenons, the disc thereof inlays into the communication equipment by inlaying the plurality of tenons into the plurality of clasps.

3. The apparatus of claim 1, wherein an opening is formed at one side of the casing of the communication equipment, the disc protrudes outside the opening to enable the user to operate the disc to switch from the first SIM card to the second SIM card.

4. The apparatus of claim 1, wherein the first slot has a plurality of columns for assisting the first SIM card in positioning within the first slot.

5. The apparatus of claim 1, wherein the second slot has a plurality of columns for assisting the second SIM card in positioning within the second slot.

6. The apparatus of claim 1, wherein the resilient pins passed through the first set of openings also assist the disc in positioning at a position.

7. The apparatus of claim 1, wherein the resilient pins passed through the second set of openings also assist the disc in positioning at a position.

8. The apparatus of claim 1, wherein one end of the first slot has a notch, extended outwardly from the first slot, for assisting the first SIM card in inserting into the first slot.

9. The apparatus of claim 1, wherein one end of the second slot has a notch, extended outwardly from the second slot, for assisting the second SIM card in inserting into the second slot.

10. The apparatus of claim 1, wherein the communication equipment is a mobile communication apparatus.

11. An apparatus for switching from a first Subscriber Identity Module (SIM) card with a set of first contact points to a second SIM card with a set of second contact points, the first SIM card and the second SIM card both being disposed on a disc rotatably mounted on an inner wall of an equipment, the disc having a circumference partially exposed outside the casing of the equipment, said apparatus comprising:
a first slot, formed on the disc, for containing the first SIM card inserted securely into the first slot where the first set of contact points on the first SIM card are disposed toward the inner wall;
a second slot, formed on the disc, for containing the second SIM card inserted securely into the second slot where the second set of contact points on the second card are disposed toward the inner wall;
a first set of openings, formed through the disc, corresponding to the first slot; and
a second set of opening, formed through the disc, corresponding to the second slot.

12. The apparatus of claim 11, wherein the disc thereon provides a plurality of clasps, the inner wall of the equipment thereon provides a plurality of tenons, the disc thereof inlays into the equipment by inlaying the plurality of tenons into the plurality of clasps.

13. The apparatus of claim 11, wherein the disc protrudes outside an opening of a casing of the equipment to enable a user to operate the disc to switch from the first SIM card to the second SIM card.

14. The apparatus of claim 11, wherein the first slot has a plurality of columns for assisting the first SIM card in positioning within the first slot.

15. The apparatus of claim 11, wherein the second slot has a plurality of columns for assisting the second SIM card in positioning within the second slot.

16. The apparatus of claim 11, wherein one end of the first slot has a notch, extended outwardly from the first slot, for assisting the first SIM card in inserting into the first slot.

17. The apparatus of claim 11, wherein one end of the second slot has a notch, extended outwardly from the second slot, for assisting the second SIM card in inserting into the second slot.

18. The apparatus of claim 11, wherein the equipment is a communication apparatus.
